(19) United States
(12) Patent Application Publication
(10) Pub. No.: US 2005/0264485 A1
(43) Pub. Date: Dec. 1, 2005

(54) Discharge display apparatus capable of adjusting brightness according to external pressure and method thereof

(76) Inventors: Seok-Gyun Woo, Suwon-si (KR); Kyoung-Doo Kang, Suwon-si (KR)

Correspondence Address: MCGUIREWOODS, LLP, 1750 TYSONS BLVD, SUITE 1800, MCLEAN, VA, 22102, US

(21) Appl. No.: 11/134,265

(22) Filed: May 23, 2005

(30) Foreign Application Priority Data
May 31, 2004 (KR) 10-2004-0039280

(51) Int. Cl. G09G 3/28

(52) U.S. Cl. 345/63

(57) ABSTRACT

A discharge display apparatus includes a discharge display panel, and a device driving the discharge display panel according to grayscale data of each frame in an input video signal. The average brightness of the frame is adjusted in proportion to an external pressure.

### CROSS-REFERENCE TO RELATED PATENT APPLICATIONS

This application claims the benefit of Korean Patent Application No. 10-2004-0039280, filed on May 31, 2004, in the Korean Intellectual Property Office, the disclosure of which is incorporated herein in its entirety by reference.

### BACKGROUND OF THE INVENTION

1. Field of the Invention

The present invention relates to a discharge display apparatus, and more particularly, to a discharge display apparatus including a discharge display panel and a device driving the discharge display panel according to grayscale data of a frame in an input video signal.

2. Description of the Related Art

FIG. 1 shows the structure of a conventional surface discharge type triode plasma display panel (PDP) 1. FIG. 2 shows an embodiment of a conventional display cell of the PDP 1 shown in FIG. 1. Referring to FIG. 1 and FIG. 2, address electrode lines A_{R1}, A_{G1}, . . . , A_{Gm}, A_{Bm}, dielectric layers 11 and 15, Y-electrode lines Y₁, . . . , Yₙ, X-electrode lines X₁, . . . , Xₙ, phosphor layers 16, partition walls 17, and a magnesium oxide (MgO) layer 12 as a protective layer are provided between front and rear glass substrates 10 and 13 of a general surface discharge PDP 1.

The address electrode lines A_{R1} through A_{Bm} are formed on a front surface of the rear glass substrate 13 in a predetermined pattern. A rear dielectric layer 15 is formed on the entire surface of the rear glass substrate 13 having the address electrode lines A_{R1} through A_{Bm}. The partition walls 17 are formed on the front surface of the rear dielectric layer 15 to be parallel 4 with the address electrode lines A_{R1} through A_{Bm}. These partition walls 17 define the discharge areas of respective display cells and operate to prevent cross communication between adjacent display cells. The phosphor layers 16 are deposited between partition walls 17.

The X-electrode lines X₁ through Xₙ and the Y-electrode lines Y₁ through Yₙ are formed on the rear surface of the front glass substrate 10 in a predetermined pattern to be perpendicular to the address electrode lines A_{R1} through A_{Bm}. The respective intersections define display cells. Each of the X-electrode lines X₁ through Xₙ has a transparent electrode line Xₙₐ (FIG. 2) made of a transparent conductive material, e.g., indium tin oxide (ITO), and a metal electrode line X_{nb} (FIG. 2) for increasing conductivity. Each of the Y-electrode lines Y₁ through Yₙ has a transparent electrode line Yₙₐ (FIG. 2) made of a transparent conductive material, e.g., ITO, and a metal electrode line Y_{nb} (FIG. 2) for increasing conductivity. A front dielectric layer 11 covers the X-electrode lines X₁ through Xₙ and the Y-electrode lines Y₁ through Yₙ. The protective layer 12, e.g., a MgO layer, for protecting the panel 1 against a strong electrical field covers the front dielectric layer 11. A gas for forming plasma is hermetically sealed in a discharge space 14.

In a driving method (see U.S. Pat. No. 5,541,618) conventionally used in the PDP 1, resetting, addressing, and sustaining-discharge are sequentially performed in a subfield. In a resetting period, a charge state becomes uniform in all display cells. In an addressing period, a predetermined wall voltage is generated in selected display cells. In a sustaining-discharge period, a predetermined alternating current (AC) voltage is applied to all XY-electrode pairs, and therefore, a sustaining-discharge occurs in display cells having the wall voltage generated in the addressing period. In the sustaining-discharge period, plasma is formed in a gas layer, i.e., the discharge space 14 in the selected display cells where the sustaining-discharge occurs, and ultraviolet rays emitted from the plasma excite the phosphor layers 16, thereby emitting light.

A driving unit for the PDP 1, i.e., discharge display panel, includes a video processor, a controller, and drivers. The video processor converts an external analog video signal into a digital signal to generate an internal video signal composed of, for example, 8-bit red (R) video data, 8-bit green (G) video data, 8-bit blue (B) video data, a clock signal, a horizontal synchronizing signal, and a vertical synchronizing signal. The controller generates drive control signals for driving the drivers in response to the internal video signal received from the video processor. The drivers apply drive signals to the electrode lines of the discharge display panel 1.

When a discharge display apparatus including the discharge display panel 1 and the driving unit is used in a region where external pressure is low, e.g., a high altitude region, stress of the discharge display panel 1 caused by the external pressure decreases, resulting in an increase in noise.

### SUMMARY OF THE INVENTION

The present invention provides a discharge display apparatus for preventing noise from increasing when the discharge display apparatus is used in a low pressure environment, e.g., the external pressure is low.

The present invention discloses a discharge display apparatus including a discharge display panel, and a device driving the discharge display panel according to grayscale data of each frame of an input video signal, wherein an average brightness of the frame is adjusted in proportion to an external pressure of the discharge display apparatus.

The present invention also discloses a method of controlling noise of a display apparatus having a discharge display panel when an external pressure of the display apparatus is low, including driving the discharge display panel according to grayscale data of each frame of an input video signal, and adjusting an average brightness of each frame in proportion to the external pressure of the discharge display apparatus, wherein the noise of the display apparatus is not increased when an image is displayed on the discharge display panel.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an internal perspective view of a conventional surface discharge type triode plasma display panel (PDP).

FIG. 2 is a sectional view of an example of a display cell of the panel shown in FIG. 1.

FIG. 3 is a block diagram of a plasma display apparatus as a discharge display apparatus according to an embodiment of the invention.

FIG. 4 is a graph illustrating that the average brightness of a frame is adjusted in proportion to the external pressure of the plasma display apparatus shown in FIG. 3.

FIG. 5 is a timing chart of a driving state in a frame when the external pressure of the plasma display apparatus shown in FIG. 3 exceeds a maximum pressure limit.

FIG. 6 is a timing chart of a driving state in a frame when the external pressure of the plasma display apparatus shown in FIG. 3 is a minimum pressure limit.

FIG. 7 is a waveform diagram of signals applied to electrode lines of the PDP shown in FIG. 1 in a subfield shown in FIG. 5 or 6.

### DETAILED DESCRIPTION OF THE ILLUSTRATED EMBODIMENTS

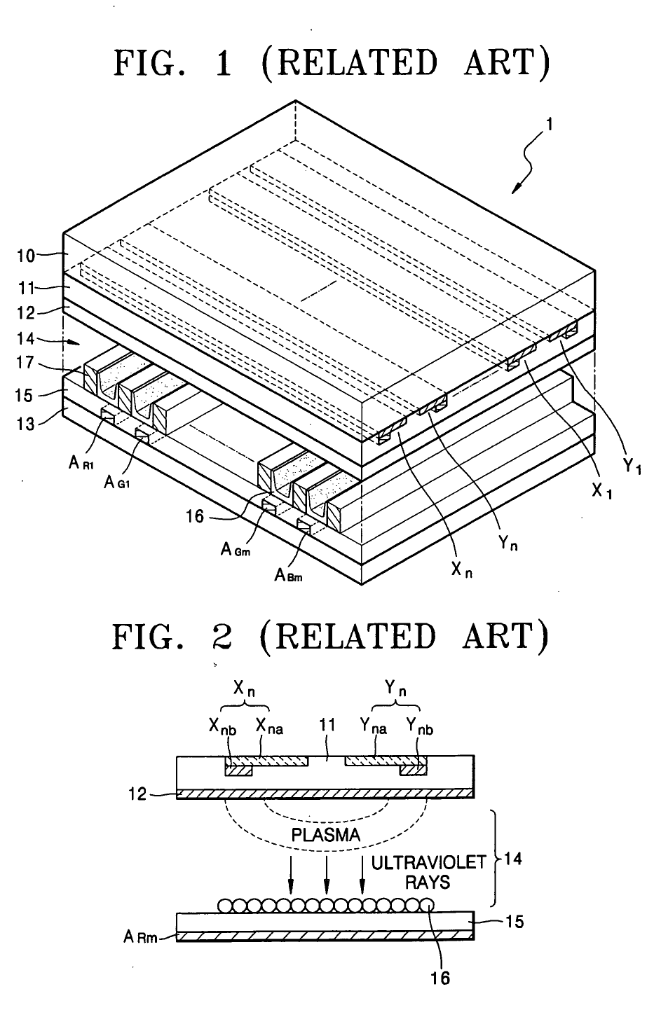

Hereinafter, several embodiments of the present invention are described in detail. In particular, a plasma display panel (PDP), i.e., a discharge display panel, included in a discharge display apparatus is described with reference to FIG. 1 and FIG. 2.

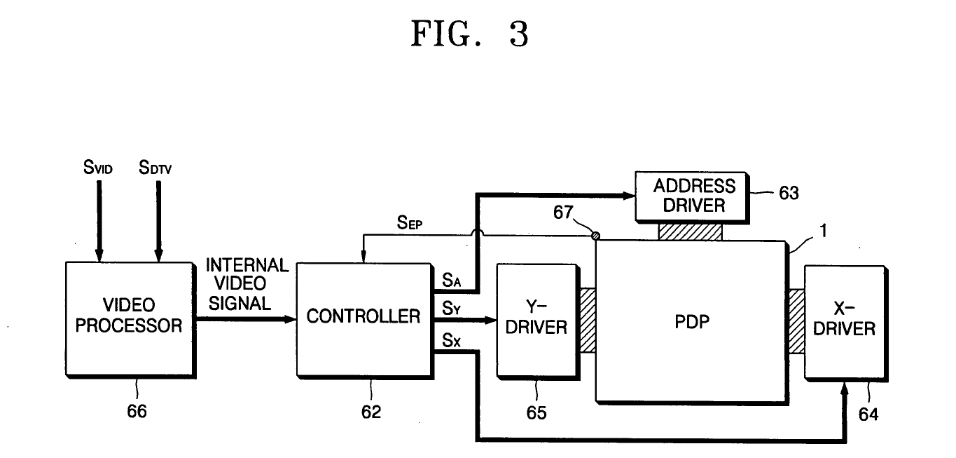

Referring to FIG. 3, a plasma display apparatus as a discharge display apparatus according to an embodiment of the present invention includes a PDP 1, a video processor 66, a controller 62, an address driver 63, an X-driver 64, a Y-driver 65, and an external pressure sensor 67.

The PDP 1 has been described above with reference to FIG. 1 and FIG. 2. The video processor 66 converts an external video signal including, for example, a video signal S_{VID} and a digital-television (DTV) signal S_{DTV}, into an internal video signal in a digital format. The internal video signal includes, for example, 8-bit red (R) video data, 8-bit green (G) video data, 8-bit blue (B) video data, a clock signal, a horizontal synchronizing signal, and a vertical synchronizing signal.

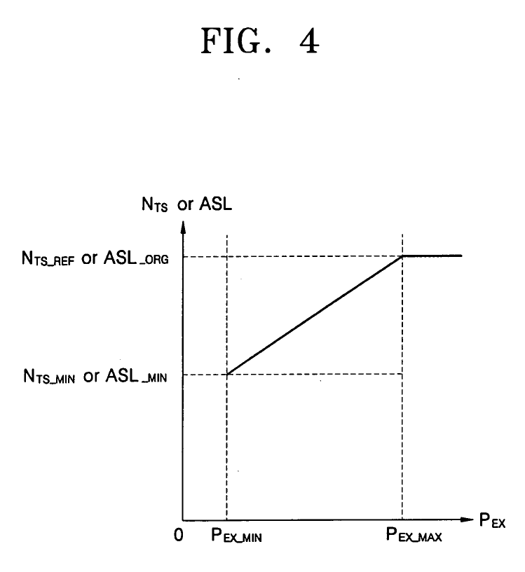

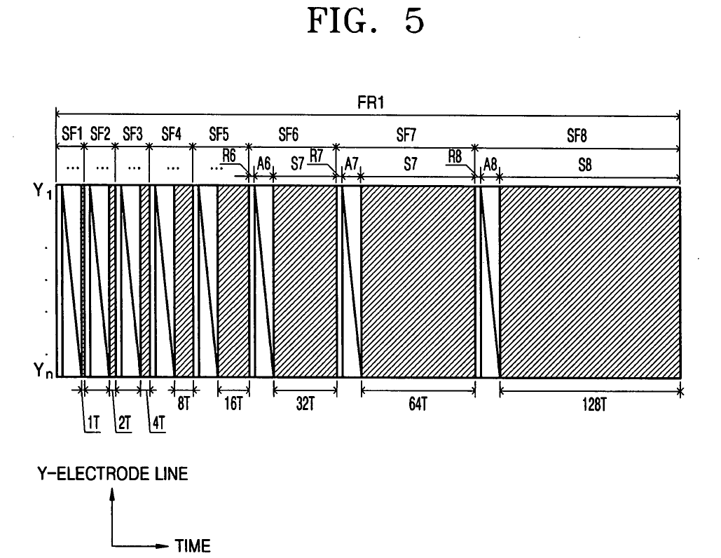

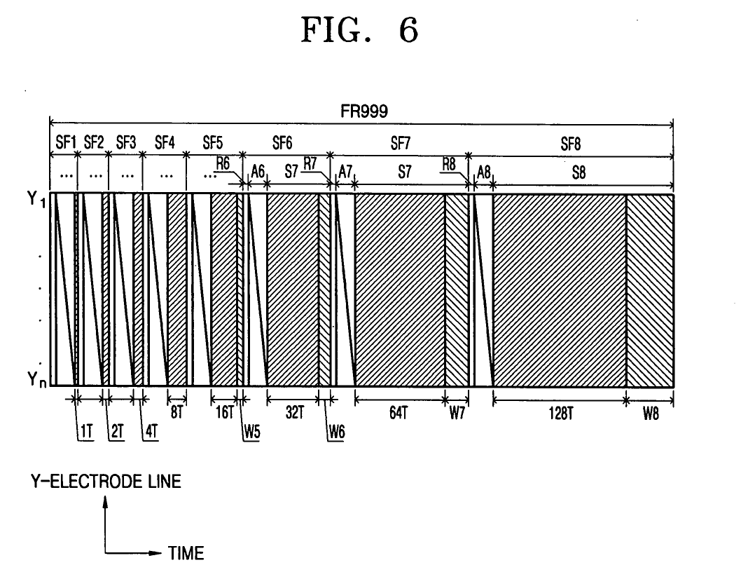

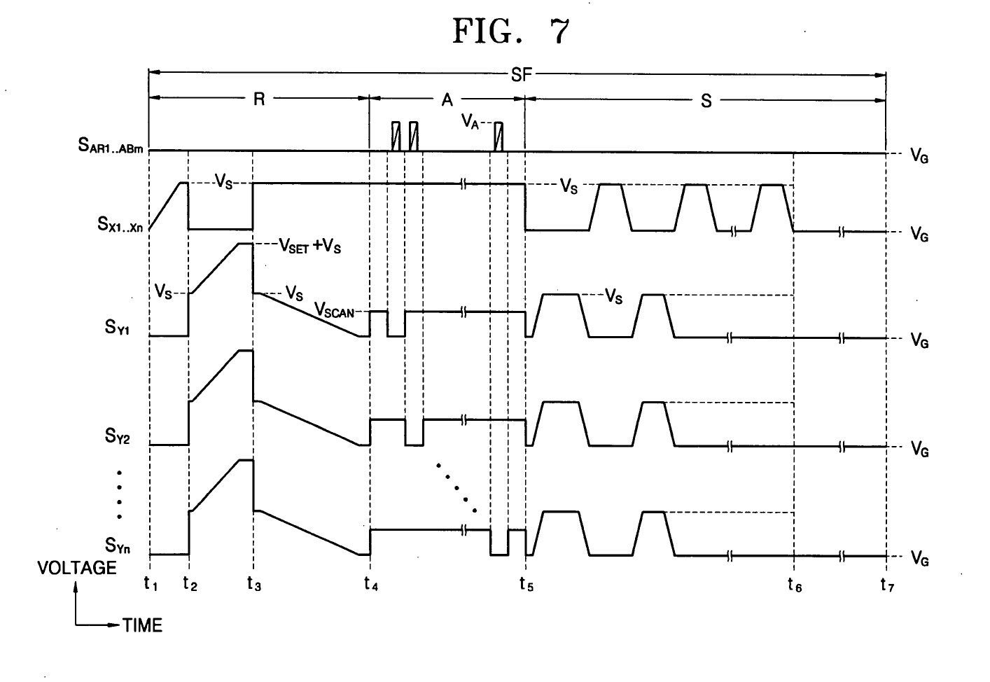

The controller 62 generates data signals S_{A}, X-control signals S_{X}, and Y-control signals S_{Y}. Here, the controller 62 adjusts an average brightness of a frame to be proportional to an external pressure according to an external pressure signal S_{EP} received from the external pressure sensor 67. Specifically, the controller 62 adjusts the average signal level of a frame or the driving time of the frame (e.g., the number of sustaining-discharge pulses in the frame) to be proportional to the external pressure. This operation will be further described with reference to FIG. 4, FIG. 5, FIG. 6, and FIG. 7.

The address driver 63 drives the address electrode lines A_{R1} through A_{Bm} (FIG. 1) of the PDP 1 according to the data signals S_{A} received from the controller 62. The X-driver 64 drives the X-electrode lines X₁ through Xₙ according to the X-control signals S_{X} received from the controller 62. The Y-driver 65 drives the Y-electrode lines Y₁ through Yₙ according to the Y-control signals S_{Y} received from the controller 62.

FIG. 4 illustrates that the average brightness of a frame is adjusted proportionally to the external pressure of the plasma display apparatus shown in FIG. 3. In FIG. 4, N_{TS} refers to the number of sustaining-discharge pulses in a frame, ASL refers to the average signal level of the frame, and P_{EX} refers to an external pressure.

Referring to FIG. 3 and FIG. 4, for example, when the external pressure P_{EX} Of the PDP 1 is between a minimum pressure limit P_{EX}_{_{—}}_{MIN} and a maximum pressure limit P_{EX}_{_{—}}_{MAX} in a frame, the number of sustaining-discharge pulses N_{TS} in the frame is set to be proportional to the external pressure P_{EX} in a range between a minimum number limit N_{TS}_{_{—}}_{MIN} and a reference number N_{TS}_{_{—}}_{REF}. This operation is described in detail with reference to FIG. 5, FIG. 6, and FIG. 7 below. The maximum pressure limit P_{EX}_{_{—}}_{MAX} is a maximum of the external pressure that does not affect the noise of the PDP 1.

Meanwhile, instead of adjusting the number of sustaining-discharge pulses N_{TS} in a frame corresponding to the driving time of the frame, the average signal level ASL of the frame may be adjusted by directly adjusting grayscale data. In detail, when the external pressure P_{EX} of the PDP 1 is between the minimum pressure limit P_{EX}_{_{—}}_{MIN} and the maximum pressure limit P_{EX}_{_{—}}_{MAX} in a frame, the average signal level ASL of the frame is set to be proportional to the external pressure P_{EX} in a range between a minimum level limit ASL_{MIN} and an original signal level ASL_{ORG}.

In general, when the external pressure P_{EX} decreases, the average brightness of a frame decreases. When the external pressure P_{EX} decreases, the internal temperature of the PDP 1 decreases, and therefore, the internal pressure of the PDP 1 decreases. Accordingly, when the external pressure P_{EX} decreases, the stress of the PDP 1 does not decrease. As a result, the noise of the PDP 1 does not increase in regions having a low external pressure PEX.

FIG. 5 is a timing chart of a driving state in a frame FR1 when the external pressure of the plasma display apparatus shown in FIG. 3 exceeds the maximum pressure limit P_{EX}_{_{—}}_{MAX} (FIG. 4). As described above, the maximum pressure limit P_{EX}_{_{—}}_{MAX} is a maximum of the external pressure that does not affect the noise of the PDP 1.

Referring to FIG. 5, to realize time-division gray scale display, a unit frame may be divided into 8 subfields SF1 through SF8. In addition, the individual subfields SF1 through SF8 may include resetting periods R1 through R8, respectively, addressing periods A1 through A8, respectively, and sustaining-discharge periods S1 through S8, respectively.

During each of the resetting periods R1 through R8, discharge conditions are made uniform in all display cells and become suitable to perform subsequent a following addressing-operation.

During each of the addressing periods A1 through A8, display data signals are applied to the address electrode lines A_{R1} through A_{Bm} of FIG. 1, and simultaneously, a scan pulse is sequentially applied to the Y-electrode lines Y₁ through Yₙ. When a high-level display data signal is applied to some of the address electrode lines A₁ through Aₘ while the scan pulse is applied, wall charges are induced from address discharge only in corresponding display cells.

During each of the sustaining-discharge periods S1 through S8, a sustaining-discharge pulse may be alternately applied to the Y-electrode lines Y₁ through Yₙ and the X-electrode lines X₁ through Xₙ, thereby provoking display discharge in display cells where wall charges are induced during each of the address periods A1 through A8. Accordingly, the brightness of a PDP is proportional to a total length of the sustaining-discharge periods S1 through S8 in a unit frame. The total length of the sustaining-discharge periods S1 through S8 in the unit frame is 255T (T is a unit time). Accordingly, including a case where the unit frame is not displayed, 256 gray scales may be displayed.

Here, for example, the sustaining-discharge period S1 of the first subfield SF1 is set to a time 1T corresponding to 2⁰. The sustaining-discharge period S2 of the second subfield SF2 is set to a time 2T corresponding to 2¹. The sustaining-discharge period S3 of the third subfield SF3 is set to a time 4T corresponding to 2². The sustaining-discharge period S4 of the fourth subfield SF4 is set to a time 8T corresponding to 2³. The sustaining-discharge period S5 of the fifth subfield SF5 is set to a time 16T corresponding to 2⁴. The sustaining-discharge period S6 of the sixth subfield SF6 is set to a time 32T corresponding to 2⁵. The sustaining-discharge period S7 of the seventh subfield SF7 is set to a time 64T corresponding to 2⁶. The sustaining-discharge period S8 of the eighth subfield SF8 is set to a time 128T corresponding to 2⁷.

Accordingly, when a subfield to be displayed is appropriately selected from among 8 subfields, a total of 256 gray scales, which includes a gray level of zero at which display is not performed in any subfield, may be displayed.

In the frame FR1 shown in FIG. 5, the external pressure of the PDP 1 shown in FIG. 3 exceeds the maximum pressure limit P_{EX}_{_{—}}_{MAX} (FIG. 4); therefore, the number of sustaining-discharge pulses NTS in each of the sustaining-discharge periods S1 through S8 is the reference number N_{TS}_{_{—}}_{REF} (FIG. 4). In other words, there is no pause in each of the sustaining-discharge periods S1 through S8.

FIG. 6 is a timing chart of a driving state in a frame FR999 when the external pressure of the plasma display apparatus shown in FIG. 3 is the minimum pressure limit P_{EX}_{_{—}}_{MIN} (FIG. 4). In FIG. 5 and FIG. 6, like reference numerals are used to denote elements having the same function and the same driving method is used in each figure. Therefore, for purposes of convenience, only differences between the driving state shown in FIG. 5 and the driving state shown in FIG. 6 are described.

Since the external pressure of the PDP 1 shown in FIG. 3 is the minimum pressure limit P_{EX}_{_{—}}_{MIN} (FIG. 4) in the frame FR999 shown in FIG. 6, the number of sustaining-discharge pulses NTS in each of the sustaining-discharge periods S1 through S8 is the minimum limit number N_{TS}_{_{—}}_{MIN} (FIG. 4). In other words, pauses W1 through W8 are present in the sustaining-discharge periods S1 through S8, respectively.

FIG. 7 illustrates waveforms of signals applied to electrode lines of the PDP 1 shown in FIG. 1 in a unit subfield SF shown in FIG. 5 or FIG. 6. In FIG. 7, S_{AR1 . . . A}_{Bm} denotes a driving signal applied to the address electrode lines A_{R1} through A_{Bm} of FIG. 1. S_{X1 . . . Xn} denotes a driving signal applied to the X-electrode lines X₁ through Xₙ of FIG. 1. S_{Y1} through S_{Yn} denote driving signals, respectively, applied to the respective Y-electrode lines Y₁ through Yₙ of FIG. 1.

Referring to FIG. 7, during a first time t₁-t₂ of the resetting period R of the unit subfield SF, a voltage applied to the X-electrode lines X₁ through Xₙ increases from a ground voltage V_{G} to a second voltage V_{S}. For example, the ground voltage V_{G} may be applied to the Y-electrode lines Y₁ through Yₙ and the address electrode lines A_{R1} through A_{Bm}. As a result, a low discharge occurs between the X-electrode lines X₁ through Xₙ and the Y-electrode lines Y₁ through Yₙ and between the X-electrode lines X₁ through Xₙ and the address electrode lines A_{R1} through A_{Bm}, so that negative wall charges are formed around the X-electrode lines X₁ through Xₙ.

During a second time t₂-t₃ for accumulation of wall charges, the voltage applied to the Y-electrode lines Y₁ through Yₙ is continuously increased from the second voltage V_{S} to a first voltage V_{SET}+V_{S} that is greater than the second voltage V_{S} by a fourth voltage V_{SET}. For example, the ground voltage V_{G} is applied to the X-electrode lines X₁ through Xₙ and the address electrode lines A_{R1} through A_{Bm}. As a result, low discharge occurs between the Y-electrode lines Y₁ through Yₙ and the X-electrode lines X₁ through Xₙ, and a lower discharge occurs between the Y-electrode lines Y₁ through Yₙ and the address electrode lines A_{R1} through A_{Bm}. The discharge between the Y-electrode lines Y₁ through Yₙ and the X-electrode lines X₁ through Xₙ is greater than the discharge between the Y-electrode lines Y₁ through Yₙ and the address electrode lines A_{R1} through A_{Bm} because negative wall charges have been formed around the X-electrode lines X₁ through Xₙ. As a result, a large amount of negative wall charges are formed around the Y-electrode lines Y₁ through Yₙ, positive wall charges are formed around the X-electrode lines X₁ through Xₙ, and a small amount of positive wall charges are formed around the address electrode lines A_{R1} through A_{Bm}.

During a third time t₃-t₄ for distribution of wall charges, the voltage applied to the Y-electrode lines Y₁ through Yₙ decreases from the second voltage Vs to a third voltage, i.e., the ground voltage V_{G} while biasing the X-electrode lines X₁ through Xₙ at the second voltage V_{S}. For example, the ground voltage V_{G} is still applied to the address electrode lines A_{R1} through A_{Bm}. As a result, some of the negative wall charges formed around the Y-electrode lines Y₁ through Yₙ move to the X-electrode lines X₁ through Xₙ due to a low discharge between the X-electrode lines X₁ through Xₙ and the Y-electrode lines Y₁ through Yₙ. Wall electric-potential of the X-electrode lines X₁ through Xₙ becomes lower than the wall electric-potential of the address electrode lines A_{R1} through A_{Bm} and higher than the wall electric-potential of the Y-electrode lines Y₁ through Yₙ. Accordingly, an address voltage V_{A}-V_{G} needed a facing discharge between selected address electrode lines and Y-electrode lines in a subsequent addressing period A may be lowered. Since the ground voltage V_{G} is applied to all of the address electrode lines A_{R1} through A_{Bm}, the address electrode lines A_{R1} through A_{Bm} provoke discharge with respect to the X-electrode lines X₁ through Xₙ and the Y-electrode lines Y₁ through Yₙ. As a result, positive wall charges formed around the address electrode lines A_{R1} through A_{Bm} disappear.

During the subsequent addressing period A, display data signals are applied to the address electrode lines A_{R1} through A_{Bm}, and a scan signal having the ground voltage V_{G} is sequentially applied to the Y-electrode lines Y₁ through Yₙ biased to a fifth voltage V_{SCAN} that is lower than the second voltage V_{S}, so that addressing can be smoothly performed. Display data signals for selecting a display cell have a positive address voltage V_{A}, and the others have the ground voltage V_{G}. Accordingly, when a display data signal having the positive address voltage V_{A} is applied while a scan pulse having the ground voltage V_{G} is being applied, wall charges are induced by address discharge in a corresponding display cell. However, wall charges are not formed in non-selected display cells. Thus, to accomplish a more accurate and efficient address discharge, the second voltage V_{S} is continuously applied to the X-electrode lines X₁ through Xₙ.

During a subsequent display-sustain period S, a display-sustain pulse having the second voltage V_{S} is alternately applied to the Y-electrode lines Y₁ through Yₙ and the X-electrode lines X₁ through Xₙ, thereby provoking a sustain discharge in display cells where wall charges are induced during the addressing period A. Here, a pause t₆-t₇ while the display-sustain pulses are not applied is inversely proportional to the external pressure P_{EX} (FIG. 4) of the PDP 1. Thus, a driving time t₅-t₆ for applying the display-sustain pulses is proportional to the external pressure P_{EX} of the PDP 1.

As described in at least the embodiments discussed above, in a discharge display apparatus according to the present invention, the average brightness of each frame is adjusted in proportion to an external pressure. Therefore, the average brightness of the frame decreases when the external pressure decreases. Accordingly, when the external pressure decreases, the internal temperature of a discharge display panel included in the discharge display apparatus decreases, thereby decreasing the internal pressure thereof. Consequently, even when the external pressure decreases, the stress of the discharge display panel does not decrease. Thus, even in a region of the discharge display panel having a low external pressure, the noise of the discharge display panel does not increase.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A discharge display apparatus comprising:
a discharge display panel; and
a device driving the discharge display panel according to grayscale data of a frame of an input video signal,
wherein an average brightness of the frame is adjusted in proportion to an external pressure of the discharge display apparatus.

2. The discharge display apparatus of claim 1, wherein an average signal level of the frame is adjusted in proportion to the external pressure of the discharge display apparatus.

3. The discharge display apparatus of claim 1, wherein a driving time of the frame is adjusted in proportion to the external pressure of the discharge display apparatus.

4. The discharge display apparatus of claim 2, wherein the frame is divided into a plurality of subfields, a subfield comprising a resetting period, an addressing period, and a sustaining-discharge period,
wherein discharge conditions are set substantially uniform throughout all display cells in the resetting period,
wherein display cells are selected in the addressing period, and
wherein discharge is sustained in the selected display cells in the sustaining-discharge period.

5. The discharge display apparatus of claim 4, wherein sustaining-discharge pulses are alternately applied to a first electrode and a second electrode of the selected display cells in the sustaining-discharge period.

6. The discharge display apparatus of claim 5, wherein a number of sustaining-discharge pulses is adjusted in proportion to the external pressure in the sustaining-discharge period.

7. The discharge display apparatus of claim 1, further comprising:
an external pressure sensor measuring the external pressure of the discharge display device; and
a controller receiving the measured external pressure from the external pressure sensor and adjusting an average signal level of the frame in proportion to the external pressure.

8. The discharge display device of claim 4, wherein the frame is divided into eight subfields.

9. A method of controlling noise of a display apparatus having a discharge display panel when an external pressure of the display apparatus is low, comprising:
driving the discharge display panel according to grayscale data of each frame of an input video signal; and
adjusting an average brightness of each frame in proportion to the external pressure of the discharge display apparatus,
wherein the noise of the display apparatus is not increased when an image is displayed on the discharge display panel.

10. The method of claim 9, further comprising:
adjusting an average signal level of the frame in proportion to the external pressure of the discharge display apparatus.

11. The discharge display apparatus of claim 9, further comprising:
adjusting a driving time of the frame in proportion to the external pressure of the discharge display apparatus.
